(19) United States
(12) Patent Application Publication
(10) Pub. No.: US 2020/0013305 A1
(43) Pub. Date: Jan. 9, 2020

(54) SKID AVOIDANCE TRAINING TIRE

(71) Applicant: Douglas Merrill Herbert, Concord, NC (US)

(72) Inventor: Douglas Merrill Herbert, Concord, NC (US)

(21) Appl. No.: 16/026,458

(22) Filed: Jul. 3, 2018

(51) Int. Cl. G09B 9/042; B60C 19/00; B60C 7/24; B60C 11/03

(52) U.S. Cl. CPC G09B 9/042; B60C 11/0327; B60C 7/24; B60C 19/001

(57) ABSTRACT

An annular tire sleeve is provided for being installed onto a tire for skid avoidance training. The sleeve has a low friction tread on the exterior surface for making contact with the road and an array of studs on the interior surface for engaging and securing the sleeve to the tire. The studs project out from the interior surface to form a point. A flange is integrally formed from an outside edge of the sleeve extending radially inward to maintain the sleeve on the tire shoulder during a skid.

### TECHNICAL FIELD AND BACKGROUND OF THE INVENTION

This invention relates to an annular tire sleeve that is installed over a traditional vehicle tire. Once the sleeve is in place, the tread surface of the sleeve makes contact with the road instead of the traditional vehicle tire tread surface. The tread surface of the sleeve is designed such that it encourages skidding at low speeds. This is useful for training drivers to control a vehicle that has entered a skid.

When a vehicle is skidding, at least one tire no longer has traction on the road surface. The ability to understand how to respond in these situations can mitigate or even prevent an accident. In order to conduct skid training in a controlled situation, the coefficient of friction between the tire and the road must be low enough to allow the tires to “break loose” or go into a skid at low vehicle speeds.

Two methodologies exist for achieving this loss of traction at low speeds. The first is a low friction surface, such as a wet surface. Installing and maintaining a low friction surface can be costly and training would be limited to the location of the low friction surface. The second is a specialty tire with a low friction tread. Replacing all of the tires on a vehicle with these specialty tires is costly. Additionally, the tread surface of these tires is such that wear and tear causes the need to frequently replace the tires which adds even more cost.

A more recent attempt to create a low friction tread on a tire involves sliding an annular sleeve onto a traditional tire. The cost of sleeves is much less than the cost of an entire tire with a specialty tread. These sleeves also reduce the cost of having to buy entire tires each time the low-friction tread wears. WO 2006/018566 shows an annular sleeve of this design having a tubular body with a convex profile that slides onto a traditional tire. Minimal friction between tubular body with a convex profile that slides onto a traditional tire. Minimal friction between the sleeve and the tire can potentially cause the sleeve to slide off of the tire during a skid.

WO 2008/093242 discloses a sleeve that has ‘teeth’ on the inside for providing a better grip between the tire and the sleeve. However these ‘teeth’ are designed such that they have a steep side and a shallow side which enables the sleeve to slide onto the tire, but does not provide optimal gripping of the tire by the ‘teeth’ in all directions while skidding. Installation of this prior art sleeve onto the tire can also prove problematic. In one disclosed design the sleeve has a flange on both sides which creates a smaller opening to slide around a tire. Another disclosed design has a point at the end that can get caught inward while sliding the sleeve around the tire.

### SUMMARY OF THE INVENTION

It is therefore an object of the present invention to provide a tire sleeve that permits drivers to be trained to anticipate and avoid or correct skids while driving a vehicle.

It is another object of the invention to provide a tire sleeve that has a multidirectional grip on the tire tread.

It is another object of the invention to provide a tire sleeve that has inherent slow friction, skid-inducing properties.

These and other objects and advantages of the present invention are achieved in the preferred embodiments set forth below by providing an annular tire sleeve for being installed onto a tire for skid avoidance training. The sleeve has a low friction tread on the exterior surface for making contact with the road and an array of studs on the interior surface for engaging and securing the sleeve to the tire. The studs project out from the interior surface to form a point. A flange is integrally formed from an outside edge of the sleeve extending radially inward to maintain the sleeve on the tire shoulder during a skid.

According to another embodiment, the annular tire sleeve rests on the tread of the tire.

According to another embodiment, the annular tire sleeve has an array of studs with at least four evenly spaced axial rows having at least twenty studs per row.

According to another embodiment, the annular tire sleeve has an array of studs where the rows in the array are radially staggered.

According to another embodiment, the annular tire sleeve has an array of studs with nine evenly spaced axial rows having thirty nine studs per row.

According to another embodiment, the annular tire sleeve has an array of studs where the rows are radially staggered by half the distance between the studs on the row.

According to another embodiment, the annular tire sleeve has studs that form a geometric cone terminating at a point.

According to another embodiment, the annular tire sleeve has a flange with an interior surface curved to conform to the curve of a shoulder of the tire and an exterior surface that is flat and parallel with respect to the outside wall of the tire.

According to another embodiment, the annular tire sleeve has a thickness that is graduated from a relatively thicker outside edge to a relatively thinner inside edge.

According to another embodiment, the annular tire sleeve has an inside edge that forms a bullnose for installing the sleeve onto the tire.

According to another embodiment, the annular tire sleeve is provided having a low friction tread on the exterior surface for making contact with the road and an array of studs on the interior surface for engaging and securing the sleeve to the tire. The array has at least four evenly spaced axial rows each having at least twenty studs per row. The studs project out from the interior surface to form a geometric cone having a point. A flange is integrally formed from an outside edge of the sleeve extending radially inward to maintain the sleeve on the tire shoulder during a skid.

According to another embodiment, the annular tire sleeve is provided having a low friction tread on the exterior surface for making contact with the road and an array of studs on the interior surface for engaging and securing the sleeve to the tire. The array has at least four evenly spaced axial rows each having at least twenty studs per row. The studs project out from the interior surface to form a geometric cone having a point. A flange is integrally formed from an outside edge of the sleeve extending radially inward to maintain the sleeve on the tire shoulder during a skid. The inside edge of the sleeve forms a bullnose for installing the sleeve onto the tire.

### BRIEF DESCRIPTION OF THE DRAWING FIGURES

The present invention is best understood when the following detailed description of the invention is read with reference to the accompanying drawings, in which:

FIG. 1 is a perspective view of the annular tire sleeve installed on a vehicle tire,

FIG. 2 is an exploded perspective view of the sleeve and tire shown in FIG. 1,

FIG. 3 is a perspective view of the annular tire sleeve,

FIG. 4 is a cross section view of the annular tire sleeve,

FIG. 5 is an enlarged partial cross section view of the sleeve shown in FIG. 4,

FIG. 5A is an enlarged partial cross section view of a single stud shown in FIG. 5,

FIG. 5B is an enlarged partial cross section view of an edge of the sleeve shown in FIG. 5, and

FIG. 6 is a cross section view of the annular tire sleeve installed on a vehicle tire.

### DETAILED DESCRIPTION OF THE PREFERRED EMBODIMENT

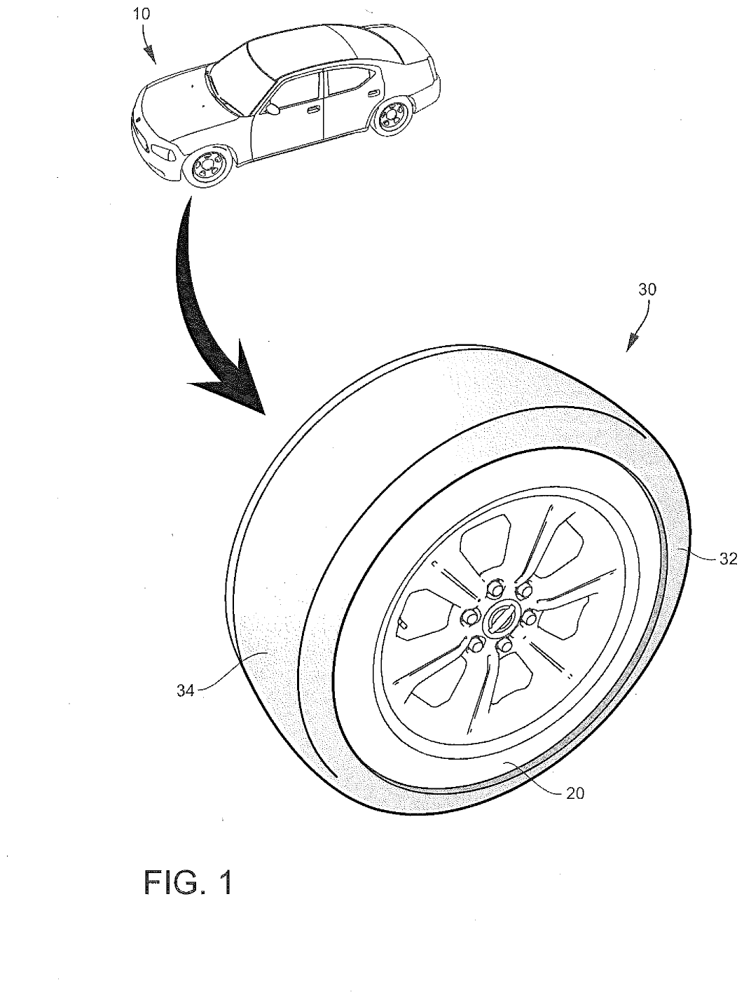

Referring now to the drawings, FIG. 1 shows an annular tire sleeve 30 installed on a tire 20 of a vehicle 10. When the sleeve 30 is installed, contact with the road is made by an exterior surface of the sleeve 34 instead of the tire 20. The sleeve 30 is made of a low friction, long wearing material such as Nylon 6. A low coefficient of friction enables the exterior surface 34 to lose traction with the road at lower vehicle speeds than traditional treaded tires. Once at least one tire 20 has lost traction, or “broken loose”, the vehicle 10 is considered to have entered a skid. While in a skid, the tire 20 is traveling in a direction traverse to the direction of travel. The ability to enter a skid at a low speed is beneficial for training drivers how to safely respond to these situations.

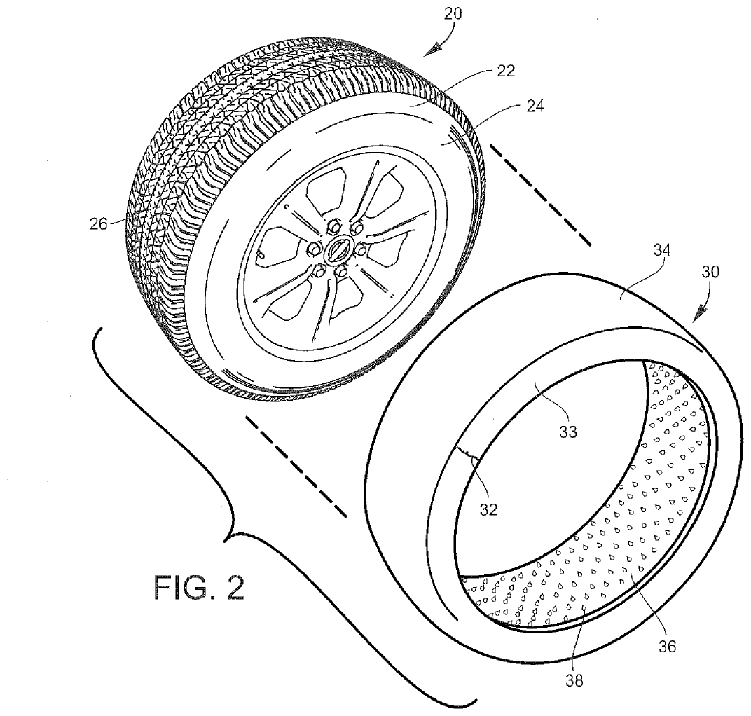

As shown in FIG. 2, the sleeve 30 is installed from an outside of the tire 20 until a flange 32 conforms to a shoulder of the tire 22 and an interior surface of the sleeve 36 is in contact with a tread surface of the tire 26. Once the sleeve 30 is installed, the exterior surface of the flange 33 is flat and parallel to the shoulder of the tire 24. In addition to guiding installation of the sleeve 30 the flange 32 also serves to prevent the sleeve 30 from shifting in an axial direction towards the vehicle. Inside and outside directions are defined in relation to the vehicle 10 when the tire 20 is installed; outside facing away from the vehicle 10 and inside facing toward the vehicle.

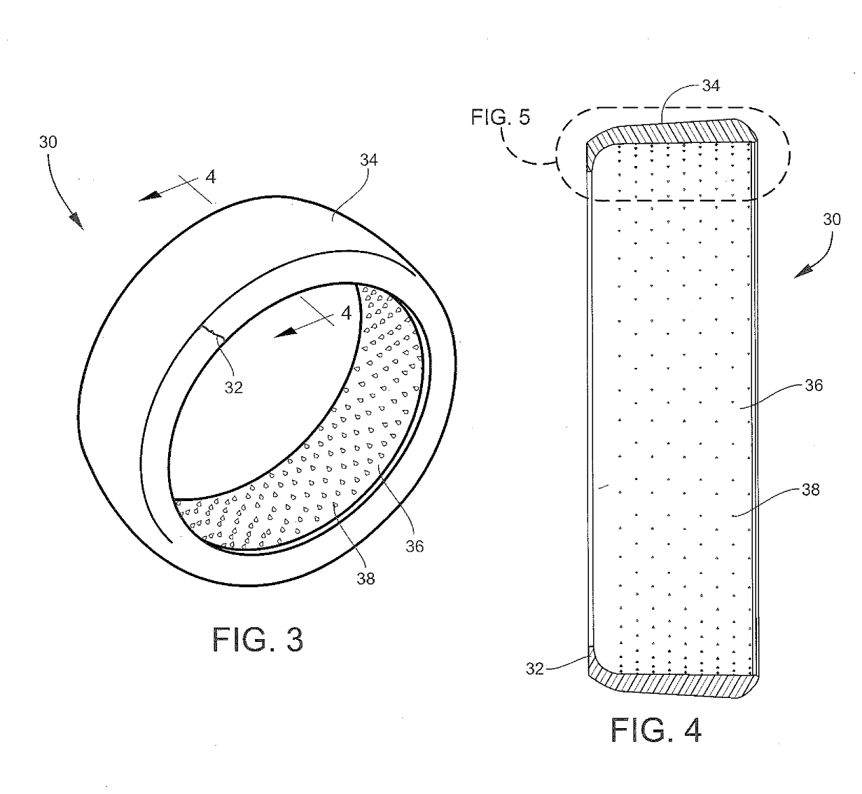

FIGS. 2, 3, and 4 show an array of studs 38 located on the interior surface 36 that engage the tread surface of the tire 26 and secure the sleeve 30 to the tire 20. The studs 38 have a conical shape and are arranged in an array having at least four axial rows of twenty studs 38 on the interior surface of the sleeve 36. Preferably there are nine evenly spaced axial rows having thirty nine evenly spaced studs 38 per row with alternating rows staggered half the distance between studs 38 on each row.

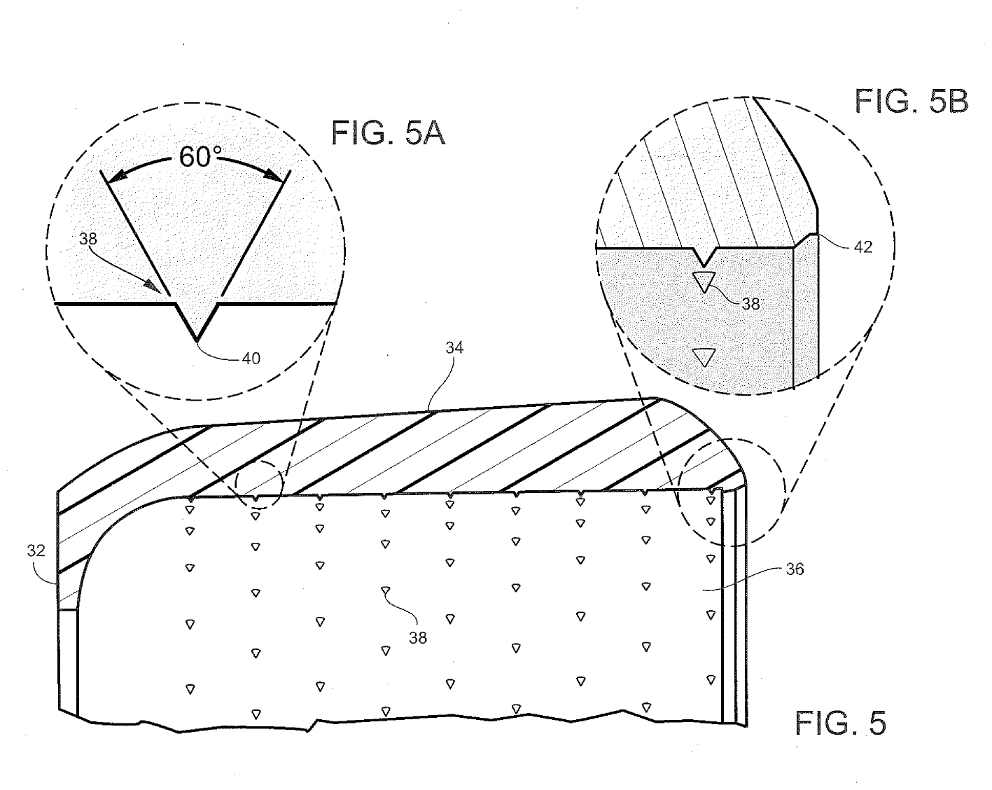

As shown in FIG. 5A, the studs have a point extending from the interior surface 36. The angle of the cross section is preferably 60°. This conical shape enables each stud 38 to maintain a grip on the tire tread 26 in all directions once the sleeve 30 is installed. Maintaining a multidirectional grip on the tire 20 reduces the risk of the sleeve 30 slipping in either an axial or radial direction during use.

As shown in FIG. 5B, the sleeve 30 has a bullnose inside edge 42. The bullnose shape of the inside edge 42 is beneficial for installation of the sleeve 30 onto the tire 20. When the sleeve 30 is installed, the bullnose shape enables the sleeve 30 to be drawn onto the tire 20 without any inward bending or damage to the inside edge 42.

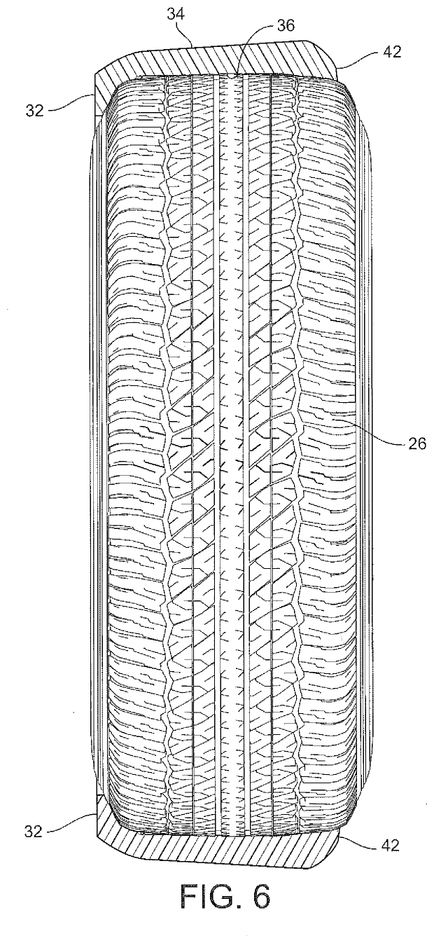

As shown in FIG. 6 the width between the interior surface 36 and the exterior surface 34 of the sleeve 30 decreases from the outside to the inside of the tire 30 along the axial direction. This creates positive camber and aids in reducing traction to encourage skidding at low speeds. In addition to creating positive camber, the graduated thickness of the sleeve width also assists in manufacturing by making the sleeve easier to remove from the mold. The inside and outside ends of the sleeve 30 are also curved toward the tire 20 forming an acute angle with the road to minimize any catching of the sleeve 30 during a skid.

An annular tire sleeve according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

What is claimed is:

1. An annular tire sleeve for being installed onto a tire for skid avoidance training, comprising:
(a) a low friction tread formed on an exterior surface of the sleeve for contacting a road surface;
(b) an interior surface of the sleeve having an array of studs projecting outwardly from the interior surface of the sleeve for engaging and securing the sleeve to the tire; and
(c) an integrally formed flange extending radially inward from an outside edge of the sleeve for maintaining the sleeve on an outside shoulder of the tire during a skid.

2. An annular tire sleeve according to claim 1, wherein the sleeve rests on the tread of the tire.

3. An annular tire sleeve according to claim 1, wherein the array of studs is evenly spaced in at least four axial rows each having at least twenty studs per row.

4. An annular tire sleeve according to claim 3, wherein the rows are radially staggered.

5. An annular tire sleeve according to claim 1, wherein the array of studs is evenly spaced in nine axial rows each having thirty nine studs per row.

6. An annular tire sleeve according to claim 3, wherein the rows are radially staggered by half a distance between the studs on the row.

7. An annular tire sleeve according to claim 1, wherein the studs form a geometric cone terminating at a point.

8. An annular tire sleeve according to claim 1, wherein the interior surface of the flange is curved to conform to the curve of a shoulder of the tire and the exterior surface of the flange is flat and parallel with respect to an outside wall of the tire.

9. An annular tire sleeve according to claim 1, wherein the sleeve thickness is graduated from a relatively thicker outside edge of the sleeve to a relatively thinner inside edge of the sleeve.

10. An annular tire sleeve according to claim 1, wherein an inside edge of the sleeve forms a bullnose for installing the sleeve onto the tire.

11. An annular tire sleeve for being installed onto a tire for skid avoidance training, comprising:
(a) a low friction tread formed on an exterior surface of the sleeve for contacting a road surface;
(b) an interior surface of the sleeve having an array of studs projecting outwardly from the interior surface of the sleeve forming a geometric cone terminating at a point for engaging and securing the sleeve to the tire;
(c) the array of studs is evenly spaced in at least four axial rows each having at least twenty studs per row; and
(d) an integrally formed flange extending radially inward from an outside edge of the sleeve for maintaining the sleeve on an outside shoulder of the tire during a skid.

12. An annular tire sleeve according to claim 11, wherein the interior surface of the flange is curved to conform to the curve of a shoulder of the tire and the exterior surface of the flange is flat and parallel with respect to an outside wall of the tire.

13. An annular tire sleeve according to claim 11, wherein the sleeve thickness is graduated from a relatively thicker outside edge of the sleeve to a relatively thinner inside edge of the sleeve.

14. An annular tire sleeve according to claim 11, wherein an inside edge of the sleeve forms a bullnose for installing the sleeve onto the tire.

15. An annular tire sleeve for being installed onto a tire for skid avoidance training, comprising:
(a) a low friction tread formed on an exterior surface of the sleeve for contacting a road surface;
(b) an interior surface of the sleeve having an array of studs projecting outwardly from the interior surface of the sleeve forming a geometric cone terminating at a point for engaging and securing the sleeve to the tire;
(c) the array of studs is evenly spaced in at least four axial rows each having at least twenty studs per row;
(d) an integrally formed flange extending radially inward from an outside edge of the sleeve for maintaining the sleeve on an outside shoulder of the tire during a skid; and
(e) a bullnose formed on an inside edge of the sleeve for installing the sleeve onto the tire.
